(19) United States
(12) Patent Application Publication
(10) Pub. No.: US 2011/0218681 A1
(43) Pub. Date: Sep. 8, 2011

(54) AIR CONDITIONING SYSTEM AND METHOD OF CONTROLLING THE SAME

(76) Inventors: Jae Sik Jung, Seoul (KR); Byoung Keun Cha, Seoul (KR); Duck Gu Jeon, Seoul (KR); Jong Hyun Han, Seoul (KR)

(21) Appl. No.: 13/041,733

(22) Filed: Mar. 7, 2011

(30) Foreign Application Priority Data
Mar. 8, 2010 (KR) 10-2010-0020331

(51) Int. Cl. G05D 23/19

(52) U.S. Cl. 700/276

(57) ABSTRACT

An air conditioning system and a method of controlling the same are provided. The air conditioning system may include at least one outdoor device, at least one indoor device connected to the at least outdoor device, voltage and current sensors installed in the at least one outdoor device, and a control device installed at or in the at least outdoor device, that collects operating information of the at least outdoor device and the at least one indoor device and calculates power consumption of the air conditioning system based on operating information, and voltage and current information. In such an air conditioning system, power consumption of the air conditioning system may be calculated via estimation using current and voltage values obtained by the current and voltage sensors and operating information of the at least one indoor device, whereby costs associated with installation of an additional power distribution device may be eliminated.

### CROSS-REFERENCE TO RELATED APPLICATION(S)

This application claims priority under 35 U.S.C. §119 to Korean Application No. 10-2010-0020331 filed in Korea on Mar. 8, 2010, whose entire content is hereby incorporated by reference.

### BACKGROUND

1. Field

An air conditioning system and a method of controlling the same are disclosed herein.

2. Background

Air conditioning systems and methods of controlling the same are known. However, they suffer from various disadvantages.

### BRIEF DESCRIPTION OF THE DRAWINGS

Embodiments will be described in detail with reference to the following drawings in which like reference numerals refer to like elements, and wherein:

FIGS. 1A and 1B are views illustrating different examples of an air conditioning system according to embodiments;

FIG. 2 is a block diagram of an air conditioning system according to an embodiment;

FIG. 3 is a block diagram of an exemplary outdoor unit of the air conditioning system of FIG. 2;

FIG. 4 is a schematic diagram of an air conditioning system according to an embodiment;

FIG. 5 is a graph illustrating power consumption calculated based on operating information of an indoor device; and

FIG. 6 is a flow chart of a method of controlling of an air conditioning system according to an embodiment.

### DETAILED DESCRIPTION

Reference will now be made in detail to embodiments, examples of which are illustrated in the accompanying drawings. Where possible, like reference numerals have been used to indicate like elements. Terms or words used in the specification and claims are not necessarily to be interpreted using typical or dictionary limited meanings, and may be constructed with meanings and concepts conforming to the technical spirit of embodiments disclosed herein based on the principle that the inventors may appropriately define the concepts of the terms to explain embodiments in the best manner possible. Accordingly, it may be understood that the detailed description, which will be disclosed along with the accompanying drawings, may be intended to describe exemplary embodiments and is not intended to represent all technical ideas. Therefore, it should be understood that various equivalents and modifications may exist which may replace the embodiments described at the time of the application.

As air conditioners become increasingly popular, a multi air conditioner system, in which indoor units or devices may be installed in respective rooms of a house or building and a common outdoor unit or device may be connected to the respective indoor devices, has been developed. In such a multi air conditioner system, the plurality of indoor devices connected to the same outdoor device may individually function to provide the respective rooms of the house or building with an air conditioning function.

To assure efficient use of electric power, it may be necessary to monitor an exact amount of kilowatts used by the air conditioning system, including the outdoor device, and the respective indoor devices. Therefore, in general, a watt hour meter that measures overall power consumption of the air conditioner and a power consumption display device that measures and displays an amount of electric power consumed by each indoor device may be frequently used.

Measuring and monitoring power consumption on a per indoor device basis may require information about power consumption of each outdoor device and each indoor device connected to the outdoor device. For example, in the case of a conventional air conditioning system, a watt hour meter and a power consumption display device may be installed on a power line connected to each outdoor device, and the power consumption display device may be configured to measure and display the amount of power consumed by each indoor device based on a combination of operating information of the indoor device and the power consumption of all of the indoor devices connected to the outdoor device that is obtained from the watt hour meter.

However, the above-described air conditioning system may cause disadvantageous increases in installation costs and time because the watt hour meter and the power consumption display device must be installed on a per outdoor device basis. In addition, the above-described air conditioning system may have a large number of elements requiring maintenance and repair, suffering from enormous maintenance and repair costs.

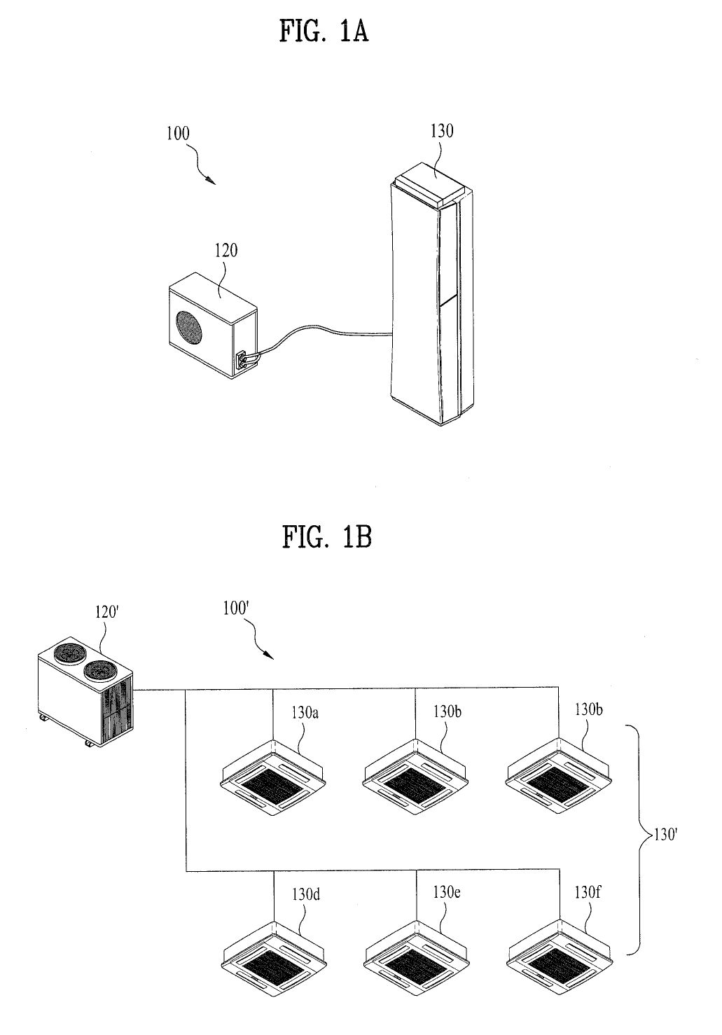

FIGS. 1A and 1B illustrate different examples of an air conditioning system according to embodiments. FIG. 1A illustrates an example of an upright air conditioning system including an indoor device and an outdoor device, and FIG. 1B illustrates an example of a ceiling-mounted air conditioning system including a single outdoor device and a plurality of indoor devices.

Referring to FIG. 1A, the air conditioning system 100, which may be suitable for use in a house, may include an outdoor device 120, and at least one indoor device 130 connected to the outdoor device 120. In this embodiment, the indoor device 130 and the outdoor device 120 may be connected to each other using a refrigerant pipe, such that the indoor device 130 may discharge low-temperature cold air into a room via heat exchange between circulating refrigerant and indoor air. In recent years, domestic air conditioning systems have been configured such that a plurality of indoor devices may be connected to a single outdoor device.

Referring to FIG. 1B, the air conditioning system 100′, which may be suitable for use in an office building, may include a single outdoor device 120′ and a plurality of indoor devices 130′. More specifically, the number of the indoor devices 130′ may be changed according to a capacity of a compressor provided in the outdoor device 120′. In the case of a large building, a plurality of outdoor devices may be provided such that a plurality of indoor devices may be connected to each outdoor device, and the respective indoor devices may be independently operated.

Although FIG. 1B illustrates an exemplary configuration in which a single outdoor device 120′ may be connected to a plurality of indoor devices 130a to 130f, for example, six. The number of the indoor devices connected to the outdoor device 120′ may be changed according to a capacity of a compressor provided in the outdoor device 120′, and also, the number of outdoor devices may be changed according to the scale of a building or the number of air conditioning spaces.

In addition to the indoor device(s) and the outdoor device, the air conditioning system may further include a ventilation device, an air purification device, a humidification device, a dehumidification device, and a heating device. In addition, the air conditioning system may be configured such that a lighting device and an alarm device may be paired with a remote controller so as to be operated thereby.

The indoor device may include an indoor heat exchanger (not shown) disposed in a room that performs room cooling/heating functions via heat exchange between indoor air and a refrigerant, an indoor fan (not shown), and a motor that rotates the indoor fan. The indoor device may further include a plurality of sensors (not shown), and a controller that controls operation of the indoor device.

The indoor device may have a discharge hole through which heat-exchanged air may be discharged. The discharge hole may be provided with an airflow control member that controls opening and closing of the discharge hole and a discharge direction of air. The indoor device may be configured to control suction or discharge of air by controlling revolutions per minute of the indoor fan, thereby enabling control of air volume. In addition, the indoor device may further include a human body sensor that senses the presence of a human body in an indoor space.

Assuming that the indoor device has at least one suction hole, and a plurality of discharge holes, including left and right discharge holes, and an upper discharge hole, the suction hole and at least one of the discharge holes may be provided with vanes. The vanes may serve not only to open or close the hole, but also to guide a flow direction of air.

The outdoor device may be operated in a cooling mode or a heating mode according to requirements of the indoor device connected thereto, or an external control signal, and may supply refrigerant to a plurality of indoor devices. The outdoor device may include a compressor that compresses refrigerant, a motor that drives the compressor, an outdoor heat exchanger that condenses the compressed refrigerant, an outdoor blowing device which may include an outdoor fan provided near the outdoor heat exchanger that facilitates heat transfer from the refrigerant and a motor that rotates the outdoor fan, an expander that expands the condensed refrigerant, a cooling/heating switching valve that changes a flow path of the compressed refrigerant, and an accumulator that supplies constant-pressure refrigerant into the compressor after removing moisture and foreign substances from gas-phase refrigerant temporarily stored therein. The outdoor device may further include a plurality of sensors, valves, and a refrigerant sub-cooling device. As these elements are well known in the art, descriptions thereof have been omitted herein.

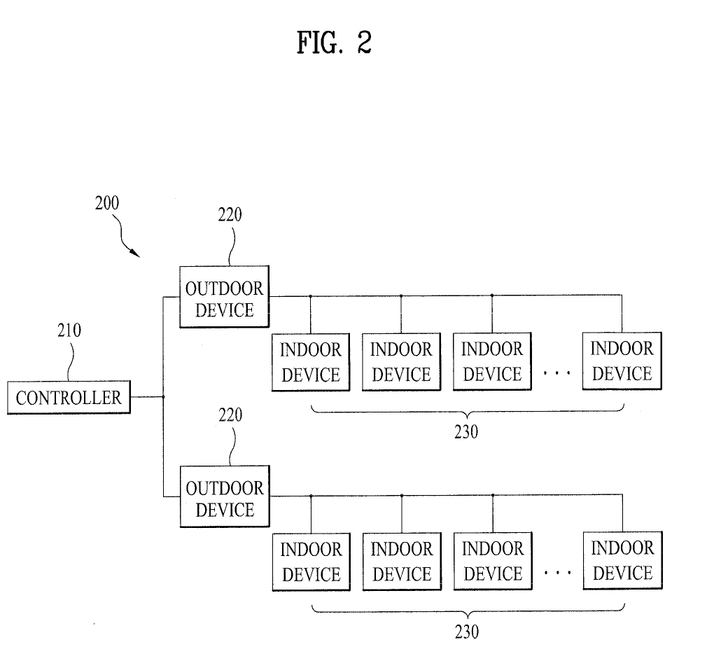

FIG. 2 is a block diagram of an air conditioning system according to an embodiment. As illustrated in FIG. 2, the air conditioning system 200 according to this embodiment may include a plurality of outdoor devices 220, for example, two, a plurality of indoor devices 230 connected to each of the plurality of outdoor devices 220, and a controller 210 that controls the plurality of outdoor devices 220 connected to the plurality of indoor devices 230. Each of the plurality of outdoor devices 220 may function to control distribution and circulation of refrigerant, and each of the plurality of indoor devices 230 connected to the plurality of outdoor devices 220 may function to cool or heat a room. In addition, the air conditioning system 200 may include a platform (not shown) provided between the outdoor devices 220 and the controller 210 and serving to connect the plurality of indoor devices 230 and the controller 210 to each other.

In a conventional air conditioning system in which a controller has no control program to individually control a plurality of indoor devices and an outdoor device, it is impossible to individually control detailed functions of each indoor device or the outdoor device. Moreover, since all of the indoor and the outdoor devices are simply connected to each other so as to be simultaneously turned on or off and the indoor devices and the outdoor device are all set to the same target temperature, the conventional air conditioning system suffers from deterioration in efficiency.

To solve the above described problems, recently, the controller used in the air conditioning system has been provided with a control program, through which a user may register setting information, including network information related to each indoor device or each outdoor device connected to the controller and appliance information of the indoor device or the outdoor device, to the controller, and also, may individually control each indoor device according to the registered setting information.

Accordingly, to increase efficiency in management of air conditioning systems used in public buildings, such as companies and schools, these air conditioning systems have been recently provided with the controller. Also, due to an enhanced performance of the outdoor device, an increased number of indoor devices may be connected to a common outdoor device such that the plurality of indoor devices and the outdoor device may be controlled in a unified manner by the controller.

Moreover, to accurately determine an amount of electric power consumed by an air conditioning system, it may be necessary to accurately determine power consumption of each outdoor device and indoor devices connected to the outdoor device included in an air conditioning system.

Hereinafter, a method of determining power consumption of an air conditioning system, including each outdoor device 220 and each indoor device 230, without a watt hour meter or a power consumption display device, as described above, will be described.

The controller 210 may be designed to control each indoor device based on power consumption of each outdoor device 220 and each indoor device 230. A detailed control method therefor will be described hereinafter.

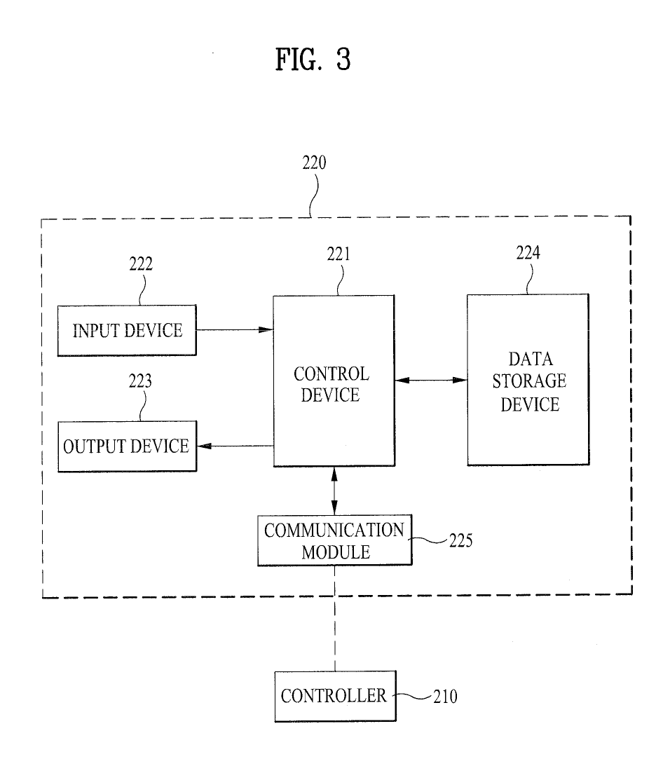

FIG. 3 is a block diagram of an outdoor unit of the air conditioning system of FIG. 2. As described above, the air conditioning system 200 according to embodiments disclosed herein may include at least one outdoor device 220, to which the plurality of indoor devices 230 may be connected, and the controller 210, which may control the outdoor device 220 connected to the indoor devices 230. The outdoor device 220 may include a data storage device 224, a communication module 225 connected to the indoor devices 230 so as to receive or transmit data, and a control device 221 that controls the outdoor device 220 and the indoor devices 230.

The data storage device 224 may store information about the outdoor device 220, including, for example, a product number of the outdoor device 220 and control data required to control the outdoor device 220, and also, may store, for example, inherent information about the indoor devices 230 connected to the outdoor device 220, information about voltage and current applied to the outdoor device 230, and operating information and connection status information of each indoor device 230.

The data storage device 224 may further store other data used in calculation of power consumption of each indoor device 230 and each outdoor device 220 via comparison with operating information of each indoor device 230 and information about voltage or current applied to the outdoor device 220.

In the air conditioning system 200 according to embodiments disclosed herein, the control device 221 may function to calculate power consumption of the air conditioning system 200, including each outdoor device 220 and each indoor device 230 based on operating information of each indoor device 230 and information about voltage or current applied to the outdoor device 220.

Although the control device 221 and the data storage device 224 may be incorporated in the outdoor device 220, they may also be mounted in the controller 210 or a specific indoor device 230. The controller 210 may also take the form of a separate terminal or a remote controller having a wireless communication function. As occasion demands, the controller 210 may be mounted in a specific indoor device 230.

The controller 210 may include an information display device 212. The information display device 212 may display power consumption calculated in the control device 221 of the outdoor device 220. The information display device 212 may be, for example, a liquid crystal display device. Assuming that the controller 210 is mounted in a specific indoor device 230, the information display device 212 may be mounted so as to be exposed to the outside.

The operating information of each indoor device 230 and information about voltage or current applied to the outdoor device 230, which may be stored in the data storage device 224, may be used for calculation of power consumption by the control device 221.

The air conditioning system 200 according to embodiments disclosed herein may be designed to calculate power consumption of the air conditioning system 200, including each outdoor device 220 and each indoor device 230, without a watt hour meter or a power consumption display device. More particularly, in the air conditioning system 200 according to embodiments disclosed herein, the power consumption of the air conditioning system 200, including each outdoor device 220 and each indoor device 230, may be calculated based on operating information of each indoor device 230 and information about voltage or current applied to the outdoor device 220, rather than being measured. Accordingly, data required to calculate power consumption of the air conditioning system 200, including each outdoor device 220 or each indoor device 230, may be collected and stored in the data storage device 224.

In addition to calculating power consumption of the air conditioning system 200, including each outdoor device 220 and each indoor device 230, using the data stored in the data storage device 224, the control device 221 may function to control each indoor device 230 and each outdoor device 220. If a control command to operate the indoor device 230 is input to the control device 221, the control device 221 may identify an address of the indoor device 230 stored in the data storage device 224 and transmit a control signal to the corresponding indoor device 230.

The control device 221 may be connected to an input device 222 that receives data to be processed in the control device 221 and inputs the data to the control device 221 and an output device 223 that receives processed data output from the control device 221. The data input by the input device 222 may be stored in the data storage device 224.

More specifically, the input device 222 may receive a control signal input via the controller 210 and other signals required to control the air conditioning system 200. The output device 223 may transmit a control signal to the indoor device 230 as well as the controller 210.

The outdoor device 220 may further be provided with the communication module 225 to enable communication between the controller 210 and the outdoor device 220. Of course, the same kind of communication module may be provided in the controller 210.

The controller 210 may be realized in the form of a universal Personal Computer (PC) or a separate exclusive control device, and may be mounted to any one of the plurality of indoor devices 230. In addition to the communication module 225, the outdoor device 220 may further be provided with a gateway (not shown) that periodically collects information about the status of the outdoor device 220 or the indoor device 230 at preset periods of time from the outdoor device 220 or indoor device 230.

The transmitted information about the status of the outdoor device 220 or the indoor device 230 may be transmitted to and stored in a unified management server (not shown), allowing users (for example, customers and service centers) to confirm information about the status of the outdoor device 220 or the indoor device 230 located at a remote place via a web connection using the Internet.

Since the outdoor device 220 may function to collect status information, operating information, or setting information of the outdoor device 220 or the indoor device 230, and transmit this information to the controller 210, if a cooling command is directly input to any one of the indoor devices 230 connected to the outdoor device 220, the controller 210 may collect status information and setting information of the corresponding indoor device 230, thereby transmitting a control signal to control condensation of refrigerant to the outdoor device 220.

In the meantime, the controller 210 may further include a control program, which may enable output of status information, operating information, or setting information of the outdoor device 220 and the indoor device 230, and thus, enable a user to input a control signal to the controller 210. The controller 210 may generate command data required to execute the control signal input through the control program.

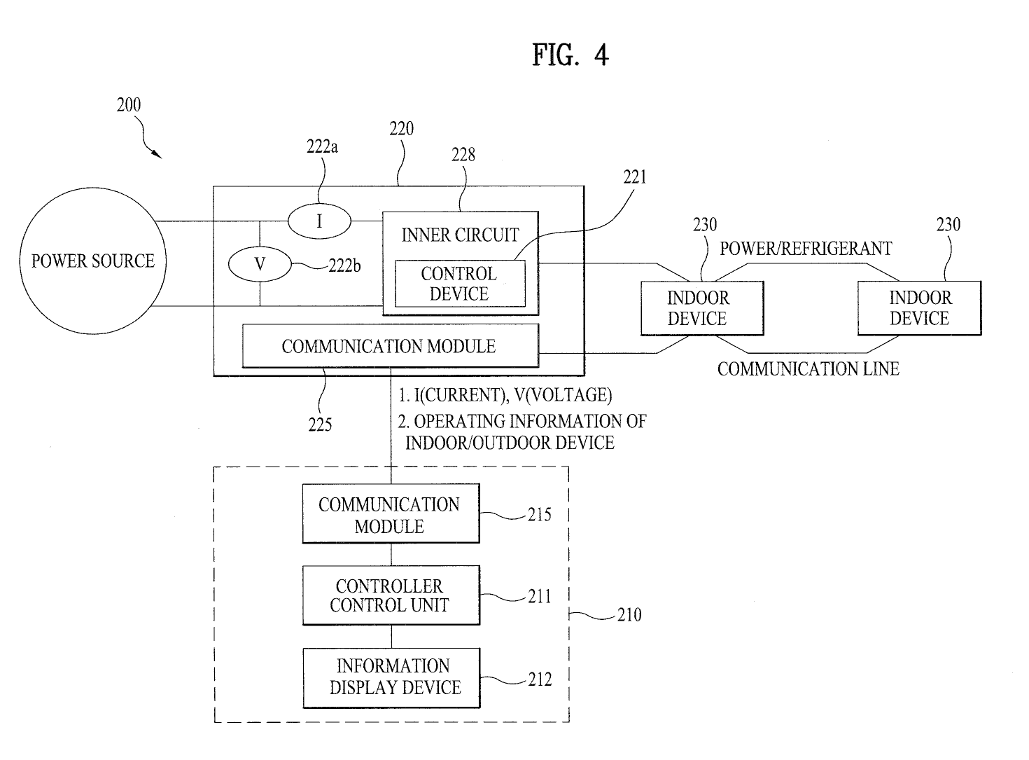

FIG. 4 is a schematic diagram of an air conditioner according to an embodiment. As illustrated in FIG. 4, the air conditioning system 200 according to this embodiment may include the outdoor device 220, the indoor devices 230, and the controller 210. The controller 210 may include a controller control device 211 and an information display device 212. The outdoor device 220 may include a current sensor 222a and a voltage sensor 222b constituting input device 222, an inner circuit 228, and communication module 225.

As described above, the air conditioning system 200 according to this embodiment may be designed to calculate power consumption of the air conditioning system 200, including the outdoor device 220 or the indoor device 230 without a watt hour meter and a power consumption display device. More particularly, in the air conditioning system 200 according to this embodiment, the power consumption of the air conditioning system 200, including each outdoor device 220 and each indoor device 230, may be calculated based on operating information of each indoor device 230 and information about voltage or current applied to the outdoor device 220, rather than being measured.

The current sensor 222a and the voltage sensor 222b may measure current or voltage applied to the outdoor device 220, which may be used to calculate power consumption of the air conditioning system 200, the outdoor device 220, or the indoor device 230.

The outdoor device 220 and the indoor device 230 may be connected, for example, over a wired network. For example, the network may be Ethernet communication using Serial Communication Protocol (SCP) or Transmission Control Protocol-Internet Protocol (TCP-IP). Also, although examples of SCP include RS-232C, RS-422 or RS-485, the air conditioning system 200 according to embodiments, for example, may adopt the RS-485 communication protocol, which may connect the outdoor device 220 and the indoor device 230 to each other to enable data communication.

The communication module 215 of the controller 210 may adopt, for example, wireless or wired communication, and may receive or transmit data from or to the outdoor device 220 and the indoor device 230. Since the outdoor device 220 and the controller 210, respectively, may include communication modules to enable data reception/transmission, if the control device 221 provided in the outdoor device 220 receives a request for transmission of the calculated power consumption from the controller 210, the communication module 225 of the control device 221 may transmit power consumption of the outdoor device 220 or the indoor device 230 to the communication module 215 of the controller 210.

To calculate power consumption per outdoor device and per indoor device, in the case of a conventional air conditioning system, a watt hour meter and a power consumption display device are installed to a power line connected to each outdoor device.

In contrast to the above-described conventional air conditioning system, the air conditioning system 200 according to embodiments disclosed herein may calculate power consumption based on the following Equations 1 and 2, instead of using a watt hour meter and a power consumption display device:

W=P×T Equation 1

Where, “W” represents power consumption per hour (Wh), “P” represents power (W), and “T” represents time (h).

P=I×V Equation 2

Where, “P” represents power (W), “I” represents current (A), and “V” represents voltage (V).

As will be appreciated from Equation 1 and Equation 2, the control device 221 of the air conditioning system 200 may calculate power consumption using a voltage value and a current value measured by the voltage sensor 222b and the current sensor 222a of the input device 222.

More specifically, if information about current and voltage applied to the air conditioning system 200 is given, the amount of watts may be calculated from Equation 2. In turn, if the amount of watts and an operating time of the outdoor device 220 and the indoor device 230 are given, the overall power consumption of the air conditioning system 200, including the outdoor device 220 and the indoor device 230, may be calculated from Equation 1.

To determine an amount of electric power consumed by each indoor device, the air conditioning system according to embodiments disclosed herein may utilize a method of calculating power consumption of each indoor device using operating information from each indoor device.

As described above, although a power consumption display device has conventionally been installed for each indoor device in order to determine power consumption of each indoor device, the air conditioning system 200 according to embodiments disclosed herein may utilize a method of calculating power consumption of each indoor device 230 based on operating information for each indoor device 230 without the power consumption display device.

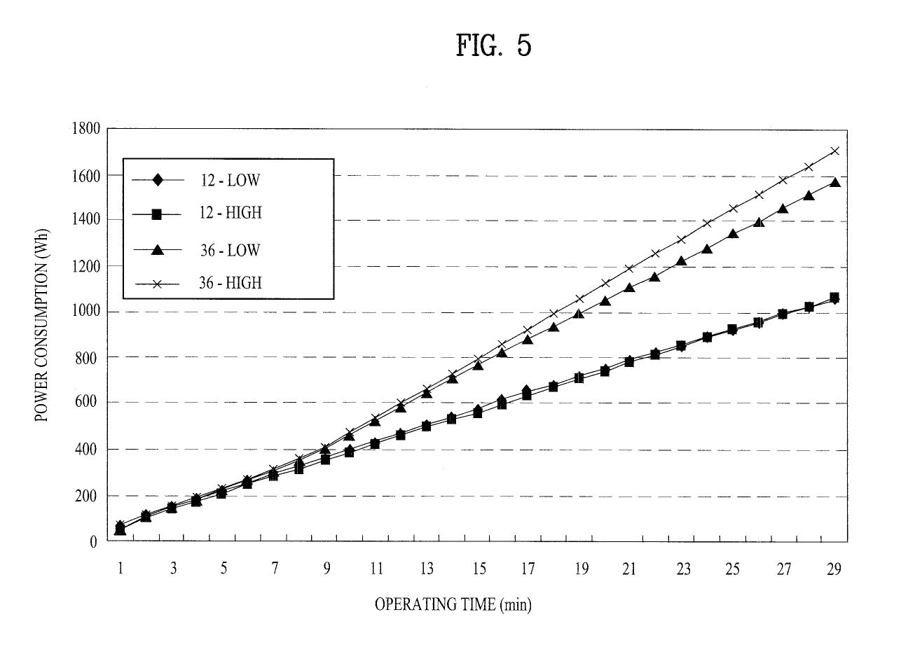

FIG. 5 is a graph illustrating power consumption calculated based on operating information of an indoor device. FIG. 5 shows power consumption versus operating time for a plurality of (four) indoor devices. In a cooling mode in which two indoor devices having different capacities (for example, air conditioning loads) are operated at the same operating temperature, power consumption per minute may be calculated as represented in the graph of FIG. 5 under the condition that the two indoor devices have the same operating conditions (for example, operating temperature) and only air volumes of the two indoor devices differ from each other.

The results as represented in the graph of FIG. 5 may also be obtained by use of a watt hour meter or a power usage display device. That is, it has been confirmed that the calculated power consumption according to embodiments disclosed herein and the measured power consumption have a negligible difference if the same control variables are applied to indoor devices of the same model. In the graph of FIG. 5, numbers in the box represent unitless values of capacities of respective indoor devices, and “LOW” and “HIGH” represent air volumes of the respective indoor devices.

It can be confirmed that power consumption is only very slightly correlated to air volume if the capacity of the indoor device has a value of 12, and that power consumption per minute increases as air volume increases if the capacity of the indoor device has a value of 36. In this way, as data related to the measured power consumption is stored in the data storage device 224 of the air conditioning system 200, the control device 221 of the air conditioning system 200 may calculate power consumption of each indoor device 230 in a specific operating mode based on the stored data.

That is, in a state in which power consumption data on a per indoor device basis is prepared based on, for example, at least one of capacity information, operating temperature information, operating time information, operating mode information; or air volume information on a per indoor device basis, power consumption of each indoor device depending on various conditions may be estimated or calculated based on the prepared data when it is necessary to confirm the power consumption. For example, assuming that the indoor device having a unitless capacity value of 12 is operated for about 20 minutes in a cooling mode, power consumption per hour of the indoor device may be estimated to a value of 800 Wh based on the prepared data. The estimated power consumption value may be stored in the data storage device 224. Here, it is noted that data depending on a change of a specific control variable may be obtained by changing the specific control variable while keeping other control variables constant.

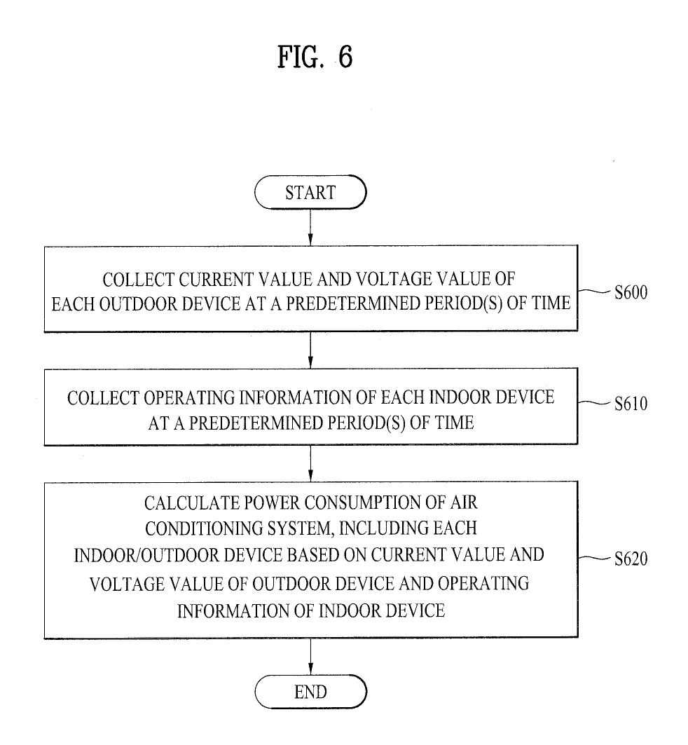

FIG. 6 illustrates a flow chart of a method of controlling an air conditioning system according to an embodiment. As illustrated in FIG. 6, a current value and a voltage value of each outdoor device may be collected at predetermined period(s) of time, in step S600, and operating information of an indoor device connected to the outdoor device may be collected at predetermined period(s) of time, in S620. As described above, the operating information of the indoor device may be, for example, at least one of capacity information, operating temperature information, operating time information, operating mode information, or air volume information on a per indoor device basis.

Thereafter, power consumption of the air conditioning system, including the outdoor device and each indoor device may be calculated based on the collected current value, voltage value, and operating information of the indoor device, in step S630.

With the above described method, it may be possible to calculate an amount of power supplied to each outdoor device based on data stored in a data storage device, rather than actually measuring the amount of power consumed by each indoor device.

Accordingly, efficient power consumption of the air conditioning system may be accomplished via calculation of power consumption of each outdoor device and each indoor device even without a watt hour meter or a power consumption display device,

In conclusion, the air conditioning system and method of controlling the same according to embodiments disclosed herein may measure energy consumption of each outdoor device and/or each indoor device without a separate watt hour meter or power consumption display device. Accordingly, with the air conditioning system and the method of controlling the same according to embodiments disclosed herein, it may be possible to eliminate time and costs associated with the purchase and installation of a watt hour meter or a power consumption display device. Moreover, omission of a watt hour meter or a power consumption display device may reduce maintenance costs and overall system failure rate, resulting in enhanced reliability.

Embodiments disclosed herein may be used to calculate power consumption of an outdoor device and an indoor device.

An air conditioning system as disclosed herein may include at least one outdoor unit or device and at least one indoor unit or device connected to the outdoor unit, which may function to calculate power consumption of the outdoor unit and the indoor unit based on a current value and a voltage value collected by a current sensing device or sensor and a voltage sensing device or sensor installed in the outdoor unit and operating information of the outdoor unit and the indoor unit, and also, may function to display the calculated power consumption.

Embodiments disclosed herein provide an air conditioning system, which may calculate power consumption of an outdoor unit or device and an indoor unit or device based on a current value and a voltage value obtained from a current sensing device or sensor and a voltage sensing device or sensor installed in the outdoor unit without separate equipment, such as a power consumption display device, and also, based on operating information of the outdoor unit and the indoor unit, and a method of controlling the air conditioning system.

Further, embodiments disclosed herein provide an air conditioning system, which may include an information display device that displays power consumption of each outdoor unit and each indoor unit so as to enable real time confirmation of power consumption of each outdoor unit and each indoor unit, and a method of controlling the air conditioning system.

Embodiments disclosed herein provide a method of controlling an air conditioning system that may include at least one outdoor unit or device and at least one indoor unit or device connected to the outdoor unit. The method may include collecting a current value and a voltage value using a current sensing device or sensor and a voltage sensing device or sensor installed in the outdoor unit, collecting operating information of the indoor unit, and calculating power consumption of the outdoor unit and the indoor unit based on the current value, the voltage value, and the operating information.

Embodiments disclosed herein further provide an air conditioning system that may include at least one outdoor unit or device, at least one indoor unit or device connected to the outdoor unit, a voltage sensing device or sensor installed in the outdoor unit, a current sensing device or sensor installed in the outdoor unit, and a control unit or device installed in the outdoor unit and serving to collect operating information of the outdoor unit and the indoor unit and calculate power consumption of the outdoor unit and the indoor unit based on the collected operating information and voltage information and current information obtained by the voltage sensing device and the current sensing device.

With an air conditioning system according to embodiments disclosed herein, power consumption of at least one outdoor unit or device and at least one indoor unit may be calculated based on a current value and a voltage value obtained from a current sensing device or sensor and a voltage sensing device or sensor installed in the outdoor unit and operating information of each indoor unit. This calculation of power consumption may have the effect of eliminating costs associated with purchase and installation of an additional power distribution device.

Further, omission of additional equipment such as the power distribution device, may have effect of minimizing maintenance and repair costs and reducing failure rate, resulting in enhanced product reliability.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of controlling an air conditioning system comprising at least one outdoor device and at least one indoor device connected to the at least one outdoor device, the method comprising:
collecting current and voltage values using a current sensor and a voltage sensor installed at or in the at least one outdoor device;
collecting operating information of the at least one indoor device; and
calculating power consumption of the air conditioning system based on the current value, the voltage value, and the operating information.

2. The method according to claim 1, wherein the operating information includes at least one of capacity information, operating temperature information, operating time information, operating mode information, or air volume information of the at least one indoor device.

3. The method according to claim 1, wherein the collecting current and voltage values and the collecting operating information are repeated at preset periods of time.

4. The method according to claim 1, further comprising:
displaying the calculated power consumption using an information display device.

5. The method according to claim 1, wherein the calculating power consumption of the air conditioning system includes calculating a power consumption of each of the at least one outdoor device and the at least one indoor device based on the current value, the voltage value, and the operating information.

6. The method according to claim 5, wherein, in the calculating of the power consumption of the air conditioning system, the power consumption is determined via estimation using data stored in a data storage device of the air conditioning system.

7. The method according to claim 5, wherein the stored data, used in the calculating of the power consumption of the air conditioning system includes measured data.

8. An air conditioning system, comprising:
at least one outdoor device;
at least one indoor device connected to the at least one outdoor device;
a voltage sensor installed at or in the at least one outdoor device;
a current sensor installed at or in the at least one outdoor device; and
a control device installed at or in the at least one outdoor device, that collects operating information of the at least one outdoor device and the at least one indoor device and calculates power consumption of the air conditioning system based on the collected operating information, and voltage information and current information obtained by the voltage sensor and the current sensor.

9. The air conditioning system according to claim 8, wherein the operating information includes at least one of capacity information, operating temperature information, operating time information, operating mode information, or air volume information of the at least one indoor device.

10. The air conditioning system according to claim 8, further comprising:
a controller connected to the at least one outdoor device and configured to receive input of a control signal required to control the air conditioning system.

11. The air conditioning system according to claim 10, wherein the at least one outdoor device and the controller, respectively, include communication modules to enable data reception/transmission, and the control device of the at least one outdoor device transmits the power consumption of the air conditioning system to the controller via the communication modules when receiving a request for transmission of the power consumption from the controller.

12. The air conditioning system according to claim 10, wherein the controller further includes an information display device that displays the power consumption calculated in the control device of the at least one outdoor device.

13. The air conditioning system according to claim 10, wherein the at least one indoor device includes a plurality of indoor devices, and the controller is mounted in any one of the plurality of indoor devices such that the information display device is exposed to the outside.

14. The air conditioning system according to claim 8, further comprising:
a data storage device that stores data used in calculation of power consumption by the control device via comparison with at least one of the operating information, the voltage information, or the current information.

15. The air conditioning system according to claim 14, wherein the data stored in the data storage device is at least one of the voltage information and the current information of the at least one outdoor device, and capacity information, operating temperature information, operating time information, operating mode information, or air volume information of the at least one indoor device.

16. The air conditioning system according to claim 15, wherein the information related to the power consumption of the air conditioning system includes measured data.

17. The air conditioning system according to claim 12, wherein the information display device further displays the operating information of the at least one indoor device.

18. The air conditioning system according to claim 12, wherein the controller is a remote controller.
